(19) United States
(12) Patent Application Publication
(10) Pub. No.: US 2013/0325738 A1
(43) Pub. Date: Dec. 5, 2013

(54) LOCATION SERVICE FOR PHYSICAL DELIVERY

(71) Applicants: Robert C. Swanson, Olympia, WA (US); Robert Bruce Bahnsen, Tacoma, WA (US); Mallik Bulusu, Olympia, WA (US)

(72) Inventors: Robert C. Swanson, Olympia, WA (US); Robert Bruce Bahnsen, Tacoma, WA (US); Mallik Bulusu, Olympia, WA (US)

(21) Appl. No.: 13/997,106

(22) PCT Filed: Dec. 15, 2011
(86) PCT No.: PCT/US2011/065105

§ 371 Date: Jun. 21, 2013

(51) Int. Cl. G06Q 10/08

(52) U.S. Cl. CPC G06Q 10/083
USPC 705/330

(57) ABSTRACT

Methods, apparatuses and storage medium associated with providing location service, are disclosed. In various embodiments, a method may include receiving, by a location server, location information associated with a user of a mobile device or a party associated with user; and receiving, by the location server, from a delivery service server, a request for the location information. The request may include a credential indicative of eligibility of the delivery service server to receive the requested location information. The method may further include providing, by the location server, to the delivery service server, the location information, on confirmation of the eligibility of the delivery service server based at least in part on the credential. Other embodiments may be disclosed or claimed.

### TECHNICAL FIELD

This application relates to the technical field of data processing, more specifically to methods and apparatuses associated with providing location service for physical delivery.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in integrated circuit, computing, networking and related technologies have led to increase in online commerce (also known as ecommerce) transactions. Recent advances have also led to widespread adoption of mobile computing devices, such as, smartphones and tablet computers (hereafter simply “mobile device”), and as a result, more ecommerce transactions being conducted through mobile devices. In many emerging countries, many users may even have a smartphone before they have a desktop or laptop computer. In the developed economy, mobility of user appears to be on the increase, resulting in ever changing preferred delivery locations.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an example network of computing devices suitable for practicing location service for physical delivery;

FIG. 2 illustrates a method for providing location service for physical delivery;

FIG. 3 illustrates an example computing device suitable for use as a server or a client device of FIG. 1; and

FIG. 4 illustrates an example non-transitory computer-readable storage medium having instructions configured to practice all or selected aspects of the method of FIG. 2; all arranged in accordance with embodiments of the present disclosure.

### DETAILED DESCRIPTION

Methods, apparatuses and storage medium associated with providing location service, are disclosed. In various embodiments, a method may include receiving, by a location server, location information associated with a user of a mobile device or a party associated with user; and receiving, by the location server, from a delivery service server, a request for the location information. The request may include a credential indicative of eligibility of the delivery service server to receive the requested location information. The method may further include providing, by the location server, to the delivery service server, the location information, on confirmation of the eligibility of the delivery service server based at least in part on the credential.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

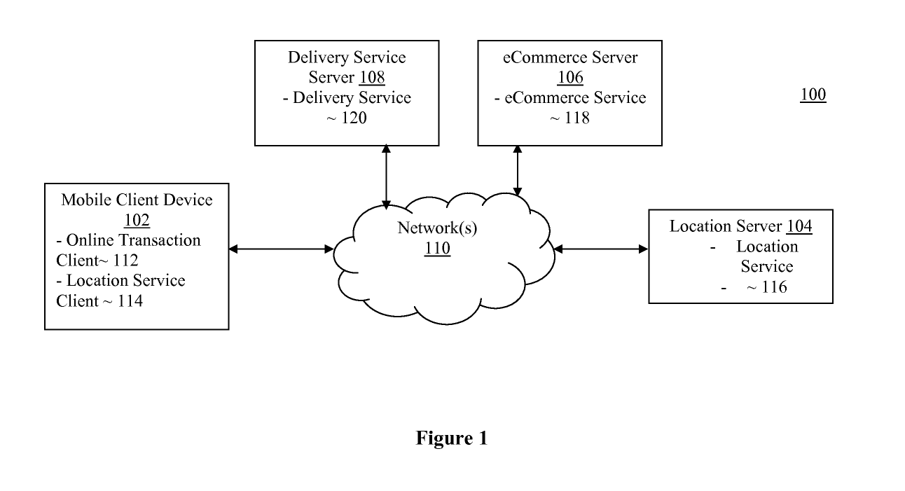

FIG. 1 illustrates an example network of computers suitable for practicing location service for physical delivery of the present disclosure, in accordance with various embodiments. As illustrated, network of computers 100 may include mobile client device 102, location server 104, ecommerce server 106 and delivery service server 108, coupled to each other via network(s) 110. Mobile client device 102 may include online transaction client 112 and location service client 114. Location server 104 may include location service 116. Ecommerce server 106 may include ecommerce service 118, while delivery service server 108 may include delivery service 120. As will be described in more detail below, location service client 114, location service 116, ecommerce service 118 and delivery service 120 may be incorporated with the teachings of the present disclosure, to enable an entity associated with delivery service 120 to effect a physical delivery of an item to a user of mobile client device 102 or a party associated with the user, at a current location or a home location of the user or party. Further, in embodiments, the delivery to a current or home location may be dependent on the nature of the item to be delivered.

In various embodiments, online transaction client 112 may be configured to access a particular ecommerce site to conduct ecommerce transactions, such as, a smartphone app, or configured to selectively access anyone of a number of ecommerce sites, and interact with the webpages of the ecommerce site to conduct online transactions, such as, a browser.

In various embodiments, location service client 114 may be configured to register a user with location service 116 for location service for physical delivery. The registration may include registering standard user information, such as user name and contact information. In particular, the registration may include a home location of the user, affiliated parties, such as spouse, parents, children, siblings and so forth, and their home locations, if different from the user's home location. Additionally, the registration may include provision or establishment of credentials a delivery service to provide, before the relevant location information may be provided to the delivery service requesting for such information. Further, the registration may optionally include establishment of rules governing whether certain items are to be delivered to home locations or current locations of the user or the affiliated parties. For examples, perishable items or items generally intended for near term consumption such as coffee, pizzas, newspapers and the like are to be delivered to the current location, whereas other durable items, such as a table, a chair, a bed, a television, and so forth are to be delivered to the home location. Still further, registration may include configuring location service 116 to accept current location reporting from wireless service providers (not shown) of mobile client device 102 or of the affiliated parties of mobile client device 102.

In various embodiments, location service client 114 may be further configured to periodically report current location of mobile client device 102 to location service 116. Location service client 114 may be configured to periodically determine the current location of mobile client device 102. Location service client 114 may be configured to periodically determine the current location of mobile client device 102 from service of a global position system component (not shown) of mobile client device 102. Location service client 114 may also be configured to determine the current location of mobile client device 102 by soliciting the information from the user of mobile client device 102.

In various embodiments, location service 116 may be configured to accept registration of users for location service for physical delivery. Location service 116 may be configured to accept the various registrations earlier described. Additionally, location service 116 may be configured to accept the periodic reporting of current locations of the various registered users and their affiliated parties, from their respective mobile client devices 102 or their wireless service providers.

Further, location service 116 may be configured to accept a request for location information from delivery service 120 to effect physical delivery of an item to a user or its affiliate. The request may explicitly request for either the current location or the home location of the user of mobile client device 102 or an affiliated party. Alternatively, the request may include a description of the item to be delivered, and thereby, implicitly request for the current location or the home location of the user of mobile client device 102 or an affiliated party. Still further, the request may include a credential that demonstrates eligibility of delivery service 120 in receiving the requested location information. In other words, location service 116 is authorized to provided the requested location information to delivery service 120. Location service 116 may be configured to validate the credentials, and provide the request location information, only on validation of the credential, confirming the eligibility of delivery service 120.

In various credentials may include one or more of a wide range of security information. Examples of security information may include, but are not limited to, passwords, biometric secrets (such as, iris, fingerprint . . . ), keys, and so forth. Credentials may be integrally provided as part of the request, or may be subsequently provided on further request, or incrementally provided through a series of exchanges.

Online transaction client 112, ecommerce service 118 and delivery service 120 (except for the teachings of the present disclosure incorporated) are intended to represent a broad range of these elements known in the art. Examples of online transaction client 112 may include, but are not limited to, a smartphone app specifically configured to conduct online transactions with a particular ecommerce site, or a generic agent, such as a browser, configured to enable online transactions via interactions with webpages of an ecommerce site. Examples of ecommerce service 118 may include, but are not limited to, any website with webpages configured for access and interaction via a browser or information pages configured for access and interaction via a specifically configured smartphone app. Examples of delivery service 120 may include, but are not limited to, any fulfillment websites configured to handle backend fulfillment for multiple frontend ecommerce sites.

Similarly, mobile client device 102 (except for its use to operate online transaction client 112 and location service client 114) is intended to represent a broad range of mobile devices known in the art, including but are not limited to smartphones, computing tablets, mobile internet devices, personal digital assistants, and other devices of the like. Examples of smartphones and computing tablets may include, but are not limited to, those available from Apple Computer of Cupertino, Calif., and Samsung Corporation of Seoul, Korea. Likewise, location server 104, ecommerce server 106 and delivery service server 108 (except for their use to respectively operate location service 116, ecommerce service 118 and delivery service 120) are intended to represent a broad range of server elements known in the art. Examples of ecommerce service 118 may include, but are not limited to, the online stores of Amazon and BestBuy. Examples of servers may include, but are not limited to, those available from Hewlett Packard of Palo Alto, CA and Dell Computer of Austin, Texas.

Network(s) 110 may include one or more wired and/or wireless, local and/or wide area, private and/or public networks. An example of public network may include the Internet.

Before proceeding to further describing location service for physical delivery of the present disclosure, it should be noted any of these elements may be combined or implemented with multiple elements providing equivalent functions. For examples, location server 104 may be a collection or cluster of computers or virtual machines, or ecommerce server 106 and delivery service server 108 may be combined, with the ecommerce service providing its own delivery service.

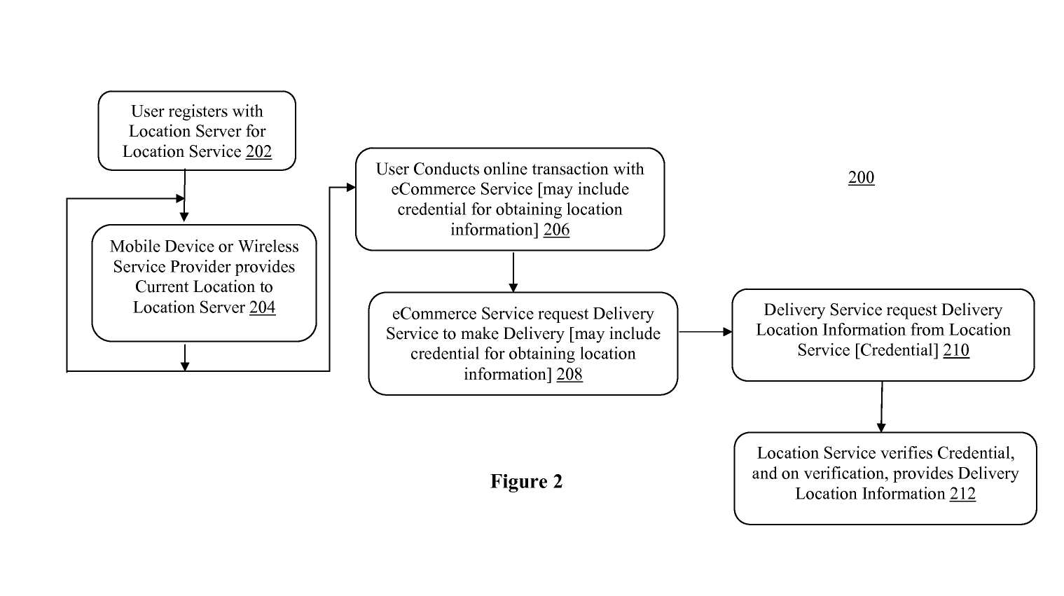

FIG. 2 illustrates a method for providing location service for physical delivery, in accordance with various embodiments. As shown, method 200 may begin at block 202 with location service client 114 registering with location service 116 for location service for physical delivery. Registration may include all or some of the earlier described aspects. On registration, from block 202, method 200 may proceed to block 204, where location service client (or wireless service providers, on its behalf) may periodically report the current location of the user of mobile client device 102. Similarly, mobile clients associated with the affiliated parties (or their wireless service providers) may periodically report the current locations of the affiliated parties, if any.

From block 204, method 200 may proceed to block 206, where online transaction client 112 may engage with ecommerce service 118 in an ecommerce transaction, which may result in the need for delivery of an item to the user or an affiliated party. In various embodiments, the transaction may include online transaction client 112 providing ecommerce service 118 with all or part of the credential (such as, a password, a secret or a seed to a symmetric key) necessary for delivery service 120 to obtain the location information to effect the delivery. In alternate embodiments, ecommerce service 118, e.g., through prior registration with ecommerce service 118, may possess in whole or in part the credentials necessary for delivery service to obtain the location information for delivery. For these embodiments, provision of the credential as part of the transaction would not be necessary.

From block 206, method 200 may proceed to block 208, where ecommerce service 118 may request delivery service 120 to effect the delivery. In various embodiments, if necessary, the request may include the credential delivery service 120 will need to obtain the delivery location information. On receipt of the request, from block 208, method 200 may proceed to block 210, wherein delivery service 118 may generate the request including information such as identity of the delivery service, identity of the user and/or an affiliated party, if applicable, an explicit request of the current or home location or an implicit request through a description of the item to be delivered, and so forth. On generation of the request, delivery service 120 may transmit the request to location service 116. In alternate embodiments, ecommerce service 118 or other components may generate the request for delivery service 120 instead.

On transmission of the request, from block 210, method 200 may proceed to block 212, where location service 116 may attempt to validate the credential to confirm the eligibility of delivery service 120 in receiving the requested location information. If unable to validate the credential or otherwise confirm the eligibility, location service 116 may reject the request, and return an error. On validation or otherwise confirmed the eligibility, location service 116 may return the requested location information. In various embodiments, location service 116 may also determine whether to return the current or home location of the user or the affiliated party, e.g., based on the registered user or default delivery rules.

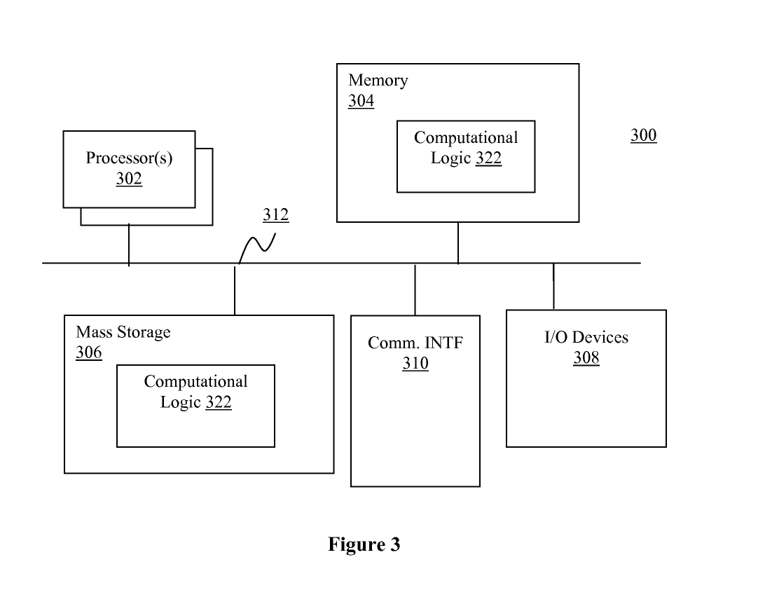

FIG. 3 illustrates an example computer system suitable for use as a client or a server of FIG. 1, in accordance with various embodiments of the present disclosure. As shown, computing system 300 includes a number of processors or processor cores 302, and system memory 304. For the purpose of this application, including the claims, the terms “processor” and “processor cores” may be considered synonymous, unless the context clearly requires otherwise. Additionally, computing system 300 includes mass storage devices 306 (such as diskette, hard drive, compact disc read only memory (CD-ROM) and so forth), input/output (I/O) devices 308, and communication interfaces 310 (such as, WiFi, Bluetooth, 3G/4G network interface cards, modems and so forth). The elements may be coupled to each other via system bus 312, which represents one or more buses. In the case of multiple buses, the multiple buses may be bridged by one or more bus bridges (not shown).

Each of these elements may be configured to perform its conventional functions known in the art. In particular, system memory 304 and mass storage 306 may be employed to store a working copy and a permanent copy of the programming instructions configured to perform operations of method 200 earlier described with references to FIG. 2, herein collectively denoted as, computational logic 322. Computational logic 322 may further include programming instructions to provide other functions, e.g., various device driver functions. The various components may be implemented by assembler instructions supported by processor(s) 302 or high-level languages, such as, e.g., C, that can be compiled into such instructions.

The permanent copy of the programming instructions may be placed into mass storage 306 in the factory, or in the field, through, e.g., a distribution medium (not shown), such as a compact disc (CD), or through communication interface 310 (from a distribution server (not shown)). That is, one or more distribution media having an implementation of computational logic 322 may be employed to distribute computational logic 322 to program various computing devices.

Otherwise, the constitution of the depicted elements 302-312 are known, and accordingly will not be further described. In various embodiments, system 300 may have more or less components, and/or different architectures.

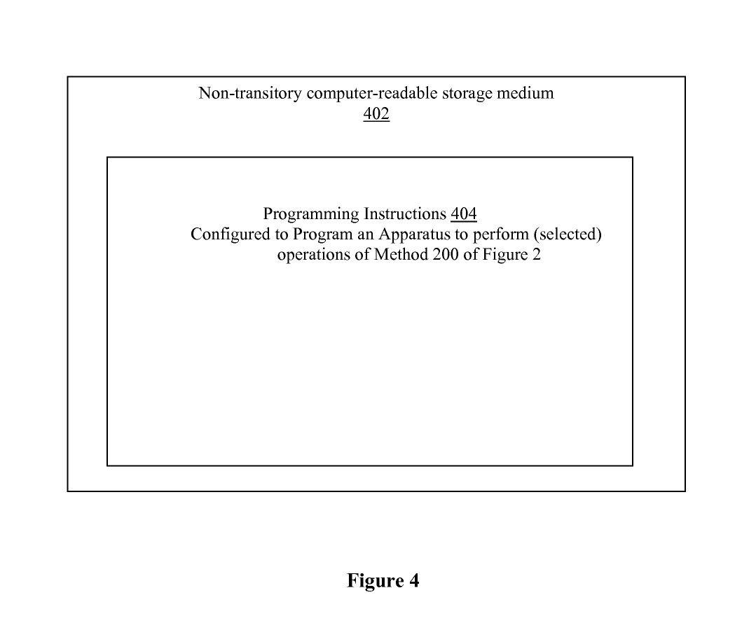

FIG. 4 illustrates an example non-transitory computer-readable storage medium having instructions configured to practice all or selected aspects of the method of FIG. 2; in accordance with various embodiments of the present disclosure. As illustrated, non-transitory computer-readable storage medium 402 may include a number of programming instructions 404. Programming instructions 404 may be configured to enable a computing device 300, in response to execution of the programming instructions, to perform the operations of online transaction client 112, location service client 114, location service 116, ecommerce service 118, and/or delivery service 120, earlier described with references to FIG. 2. In alternate embodiments, programming instructions 404 may be disposed on multiple non-transitory computer-readable storage media 402 instead.

Referring back to FIG. 3, for one embodiment, at least one of the processor(s) 302 may be packaged together with computational logic 322 configured to practice selected aspects of the method of FIG. 2. For one embodiment, at least one of the processor(s) 302 may be packaged together with computational logic 322 configured to practice selected aspects of the method of FIG. 2 to form a System in Package (SiP). For one embodiment, at least one of the processor(s) 302 may be integrated on the same die with computational logic 322 configured to practice selected aspects of the method of FIG. 2. For one embodiment, at least one of the processor(s) 302 may be integrated on the same die with computational logic 322 configured to practice selected aspects of the method of FIG. 3 to form a System on Chip (SoC). For at least one embodiment, the SoC may be utilized in a smartphone, a computing tablet, or other mobile device.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. At least one non-transitory computer-readable storage medium having a plurality of instructions configured to enable a mobile device, in response to execution of the instructions by the mobile device, to:
determine a current location of a user or a party associated with the user; and
provide to a location server, the current location information, to enable the location server to provide the current location information to an eligible recipient associated with effecting a physical delivery to the user or the party.

2. The at least one computer-readable storage medium of claim 1, wherein the plurality of instructions are further configured to enable the mobile device, in response to execution of the instructions by the mobile device, to determine the current location through usage of service of a global positioning system, or through receipt of the current location from the user.

3. The at least one computer-readable storage medium of claim 1, wherein the plurality of instructions are further configured to enable the mobile device, in response to execution of the instructions by the mobile device, to provide to an online server, as part of an online transaction, security information, for the online server or a delivery server associated with the online server, to demonstrate to the location server eligibility of the online server or the delivery server to receive location information associated with the user or the party associated with the user, to effect the physical delivery, wherein the physical delivery is associated with the online transaction.

4. (canceled)

5. (canceled)

6. (canceled)

7. An apparatus for using location service for physical delivery, comprising:
a processor and memory arrangement; and
a location service client configured to be operated by the processor and memory arrangement to provide a location server with location information of a user of the apparatus or a party associated with the user, wherein the location server is configured to operate a location service for conditional provision of the location information to an eligible delivery server for physical delivery of an item to the user or the party associated with the user.

8. The apparatus of claim 7, wherein the location information comprise a current location of the user or the party associated with the user, and the location service client is further configured to determine the current location.

9. The apparatus of claim 7, wherein the location service client is further configured to provide to an online server, as part of an online transaction, security information, for the online server or a delivery server associated with the online server, to demonstrate to the location server eligibility of the online server or the delivery server to receive location information associated with the user or the party associated with the user, to effect the physical delivery, wherein the physical delivery is associated with the online transaction.

10. The apparatus of claims 9, wherein the apparatus comprises a selected one of a smartphone, a computing tablet, a mobile internet device, or a personal digital assistant.

11. At least one non-transitory computer-readable storage medium having a plurality of instructions configured to enable a location server, in response to execution of the instructions by the location server, to:
receive location information associated with a user of a mobile device or a party associated with user;
receive, from a delivery server, a request for the location information, the request to include a credential indicative of eligibility of the delivery server to receive the location information; and
provide, to the delivery server, the location information, on confirmation of the eligibility of the delivery server based at least in part on the credential.

12. The at least one computer-readable storage medium of claim 11, wherein the plurality of instructions, in response to execution by the location server, enable the location server, to receive, from the mobile device or a wireless service provider, location information of the user or the party associated with the user.

13. The at least one computer-readable storage medium of claim 11, wherein the plurality of instructions, in response to execution by the location server, enable the location server, to receive a current location or a home location of the user or the party associated with the user.

14. The at least one computer-readable storage medium of claim 11, wherein the plurality of instructions, in response to execution by the location server, enable the location server, to receive, from the delivery server, a request for a current location or a home location of the user or the party associated with the user.

15. The at least one computer-readable storage medium of claim 11, wherein the plurality of instructions, in response to execution by the location server, enable the location server, to receive a request, from a delivery server associated with a party associated with making a physical delivery of an item to the user or the party associated with the user.

16. The at least one computer-readable storage medium of claim 15, wherein the plurality of instructions, in response to execution by the location server, enable the location server, to receive, from the delivery server, a request for a location of the user or the party associated with user, and the request includes a description of item; wherein provide comprises provide a current location or a home location, further based at least in part on the description of the item.

17. (canceled)

18. (canceled)

19. (canceled)

20. (canceled)

21. (canceled)

22. (canceled)

23. (canceled)

24. (canceled)

25. An apparatus for providing location service for physical delivery, comprising:
a processor and memory arrangement; and
a location service configured to be operated by the client to
receive location information associated with a user of a mobile device or a party associated with user;
receive, from another apparatus, a request for the location information, the request to include a credential indicative of eligibility of the other apparatus to receive the location information; and
provide, to the other apparatus, the location information, on confirmation of the eligibility of the other apparatus based at least in part on the credential.

26. The apparatus of claim 25, wherein the location service is configured to receive location information of the user or the party associated with the user, from the mobile device or a wireless service provider.

27. The apparatus of claim 25, wherein the location service is configured to receive a current location or a home location of the user or the party associated with the user.

28. The apparatus of claim 5, wherein the location service is configured to receive, from the other apparatus, a request for a current location or a home location of the user or the party associated with the user.

29. The apparatus of claim 25, wherein the location service is configured to receive a request, from another apparatus associated with a party associated with making a physical delivery of an item to the user or the party associated with the user.

30. The apparatus of claim 29, wherein the location service is configured to receive, from the other apparatus, a request for a location of the user or the party associated with user, and the request includes a description of item; wherein the location service is additionally configured to provide a current location or a home location, based further on the description of the item.

31. At least one non-transitory computer-readable storage medium having a plurality of instructions configured to enable a delivery server, in response to execution of the instructions by the delivery server, to:
receive or generate a request to request location information for a party in association with effecting a physical delivery of an item to the party, including a credential demonstrating eligibility of the delivery server in receiving the location information;
transmit the request to a location server; and
receive the requested location information.

32. The at least one computer-readable storage medium of claim 31, wherein the location information comprises a current location or a home location of the party, and the party is a user of a mobile device or associated with a user of a mobile device.

33. The at least one computer-readable storage medium of claim 31, wherein the request further comprises description of the item, and the location information received from the location server comprises a current location or a home location of the party, based at least in part on the description of the item.

34. The at least one computer-readable storage medium of claim 31, wherein the plurality of instructions are further configured to enable an online server, in response to execution of the instructions by the online server, to conduct an online transaction with a mobile device, wherein the mobile device is associated with the party or a user associated with the part, and the physical delivery is associated with the online transaction.

35. The at least one computer-readable storage medium of claim 34, wherein the online server comprises the delivery server, and receive or generate a request comprise generate a request.

36. (canceled)

37. (canceled)

38. (canceled)

39. (canceled)

40. (canceled)

41. An apparatus for using location service for physical delivery, comprising:
a processor and memory arrangement; and
a delivery service configured to be operated by the processor and memory arrangement to receive or generate a request to request location information for a party in association with effecting a physical delivery of an item to the party, including a credential demonstrating eligibility of the apparatus to receive the location information;
transmit the request to a location server; and
receive, from the location server, the requested location information.

42. The apparatus of claim 41, wherein the location information comprises a current location or a home location of the party, and the party is a user of a mobile device or associated with a user of a mobile device.

43. The apparatus of claim 41, wherein the request further comprises description of the item, and the location information received from the location server comprises a current location or a home location of the party, based at least in part on the description of the item.

44. The apparatus of claim 41, further comprising an online server configured to conduct an online transaction with a mobile device, wherein the mobile device is associated with the party or a user associated with the party, and the physical delivery is associated with the online transaction.

45. (canceled)
